(19) United States
(12) Patent Application Publication
(10) Pub. No.: US 2007/0169073 A1
(43) Pub. Date: Jul. 19, 2007

(54) Update package generation and distribution network

(76) Inventors: Patrick O'Neill, Dana Point, CA (US); Bindu Rama Rao, Austin, TX (US)

Correspondence Address: MCANDREWS HELD & MALLOY, LTD, 500 WEST MADISON STREET, SUITE 3400, CHICAGO, IL, 60661, US

(21) Appl. No.: 10/411,835

(22) Filed: Apr. 11, 2003

Related U.S. Application Data
(60) Provisional application No. 60/373,422, filed on Apr. 12, 2002.
(60) Provisional application No. 60/373,421, filed on Apr. 12, 2002.
(60) Provisional application No. 60/373,423, filed on Apr. 12, 2002.
(60) Provisional application No. 60/372,066, filed on Apr. 12, 2002.

(51) Int. Cl. G06F 9/44

(52) U.S. Cl. 717/168

(57) ABSTRACT

An update package generation and distribution network facilitates the generation of update packages and the download of update packages to mobile devices employing pull-mode or push-mode mechanisms. The update packages may be created by a manufacturer or by the carrier employing a generation environment. Specifically, the update package generation and distribution network makes it possible to conduct over-the-air (OTA) updates to firmware and software on the mobile device by accessing update packages that are generated by the generation environment or by the manufacturer's generation environment and distributed by the update environment.

### CROSS-REFERENCE TO RELATED APPLICATIONS/INCORPORATION BY REFERENCE

This application makes reference to and claims priority based on the following provision applications, the complete subject matter of each of which is incorporated herein by reference in its entirety.

| Ser. No. | Docket No. | Title | Filed | Inventors |
|---|---|---|---|---|
| 60/373,422 | 13888US01 | Update Package Generation and | Apr. 12, 2002 | O'Neill |
| | | Distribution Network | | Rao |
| 60/373,421 | 13889US01 | Pattern Detection Preprocessor in an | Apr. 12, 2002 | Chen |
| | | Update Generation System | | O'Neill |
| | | | | Rao |
| | | | | Lilley |
| 60/373,423 | 13890US01 | Layout Preprocessor in an Update | Apr. 12, 2002 | Chen |
| | | Generation System | | O'Neill |
| | | | | Lim |
| | | | | Jacobi |
| | | | | Sotos |
| 60/372,066 | 13922US01 | Memory Initialization System for | Apr. 12, 2002 | Chen |
| | | Initializing a Memory Image with a | | O'Neill |
| | | Pattern | | |

This application is a continuation-in-part of U.S. patent application Ser. No. 10/311,462, “System and Method for Updating and Distributing Information”, filed Dec. 13, 2002, which is the National Stage filing of PCT Application Ser. No. PCT/US01/44034, “System and Method for Updating and Distributing Information”, filed Nov. 19, 2001, which claims priority to U.S. Provisional Patent Application Ser. No. 60/249,606, filed Nov. 17, 2000, the complete subject matter of each of which is incorporated herein by reference in its entirety.

This application is also related to the following co-pending applications, each of which is hereby incorporated herein by reference in its entirety:

| Ser. No. | Docket No. | Title | Filed | Inventors |
|---|---|---|---|---|
| | 13889US02 | Pattern Detection Preprocessor in an | Apr. 11, 2003 | Chen |
| | | Electronic Device Update Generation | | O'Neill |
| | | System | | Rao |
| | | | | Lilley |
| | 13890US02 | Initialization and Update of Firmware | Apr. 11, 2003 | Chen |
| | | in Electronic Devices | | O'Neill |

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. These firmware and application software often contain software bugs. New versions of the firmware and software are periodically released to fix the bugs or to introduce new features, or both. There is a fundamental problem in providing access to new releases of firmware and software. The electronic devices are often constrained in terms of resources, such as the amount of memory available. Attempts by end-users to upgrade firmware and/or software often result in making the device, or some features of the device, inoperable. Such attempts are often hampered by limited user interaction capabilities and slow communication speeds of these devices. In addition, determination of the current version of firmware or software in use on the electronic devices is a difficult task, especially if such determination has to be made without requiring any (or minimal) end-user interactions.

Typically, a carrier network supports the usage of cellular phones from a plurality of manufacturers. It is often difficult for a carrier to determine the make and model of a phone currently being used on the carrier's network. This problem is more acute in GSM based carrier networks where a user can swap phones and still be able to receive service from a carrier. For example, the end-user can employ the same subscriber identity module (SIM) card in different mobile phones and access communication services provided by a carrier. Therefore, determining what phone an end-user is currently using may be a problem. Without automatically determining and verifying this information, updating the firmware or software of, for example, a cellular phone (to fix bugs or provide a different set of features) is impossible, for fear of providing the wrong firmware or software, potentially causing it to malfunction.

An additional problem relates to the fact that users of electronic devices such as, for example, cellular phones are normally completely unaware of the availability of a software and/or firmware update for their electronic device. There is currently no standard way of sending an electronic notification of the availability of updated software and/or firmware for electronic devices such as a cellular phone. In addition, when software and/or firmware updates are made available and users are notified, it becomes the responsibility of the user of the electronic device to deliver the device to a particular physical location to have the device updated. The lack of end-user notification, and the inconvenience of delivering the device reduce the likelihood that these devices are kept up-to-date.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be seen in an updateable electronic device communicatively coupled to a carrier network. In an embodiment of the present invention, the updateable electronic device may comprise at least one of firmware and software, and at least one identifying characteristic. The updateable electronic device communicates the at least one identifying characteristic to the carrier network and receives an indication sent by the carrier network of the need to update at least one of the firmware and the software. The updateable electronic device may further comprise a download agent and an update agent. The download agent downloads an update package sent from the carrier network and verifies that the downloaded update package is appropriate for the updateable electronic device. The update agent updates at least one of the firmware and the software using the update package sent by the carrier network.

Another aspect of the present invention may be seen in a method of operating a carrier network. In such an embodiment, the carrier network may be communicatively coupled to at least one updateable electronic device comprising a code and at least one identifying characteristic. The method may comprise receiving from the at least one updateable electronic device the at least one identifying characteristic, and sending to the at least one updateable electronic device a signal indicating a need to perform an update of the code based upon the at least one identifying characteristic. The code may be at least one of firmware and software, and the carrier network may be a wireless network. In an embodiment of the present invention, the at least one updateable electronic device may comprise an update agent, and the receiving may comprise, under the control of the update agent, accepting an update package from the carrier network; and updating the code in the updateable electronic device using the update package. In addition, the at least one updateable electronic device may comprise a download agent, and the accepting may comprise, under the control of the download agent, downloading the update package from the carrier network; and verifying that the update package is appropriate for the at least one updateable electronic device.

Yet another aspect of the present invention may be observed in an update network comprising at least one updateable electronic device communicatively coupled to a server. The server has stored thereon at least one update package. The updateable electronic device comprises an update agent for retrieving the at least one update package and a download agent for verifying that the at least one update package is appropriate for the at least one updateable electronic device. The at least one update package may comprise at least one of software and firmware, and the verifying may comprise checking that the update package originated from the manufacturer of the updateable electronic device.

Another aspect of the present invention may be seen in a method of operating an update network. The update network comprises at least one updateable electronic device communicatively coupled to a server. The updateable electronic device comprises at least one of software and firmware and is characterized by its manufacturer, and the server stores at least one update package. The method of such an embodiment may comprise, under control of the server, receiving the at least one update package, storing the at least one update package on the server if the at least one update package was generated by the manufacturer of the at least one updateable electronic device, determining that the at least one updateable electronic device needs to be updated, and notifying the at least one updateable electronic device that an update is needed. The method may further comprise, under control of the at least one updateable electronic device, receiving a notification the update is needed, requesting from the server the at least one update package, accepting the at least one update package, verifying the at least one update package, and updating at least one of the software and the firmware of the updateable electronic device using the at least one update package.

A further aspect of the present invention may be seen in an update network comprising at least one updateable electronic device communicatively coupled to a plurality of servers. Each of the plurality of servers comprises a propagation layer for propagating a plurality of update packages from at least one of the plurality of servers to the others of the plurality of servers, where the update network manages the propagation of the plurality of update packages. The plurality of servers may also comprise an aggregation layer for aggregating information related to the operation of the plurality of servers, where the update network manages the aggregation.

Aspects of the present invention may also be observed in a carrier network for updating a plurality of updateable electronic devices from a first operating code to a second operating code in an over-the-air mode. Each of the plurality of updateable electronic devices comprises a memory containing a copy of the first operating code and at least one identifying characteristic, where the updating to the same second operating code of those of the plurality of updateable electronic devices having the same at least one identifying characteristic results in identical memory contents.

Additional aspects of the present invention may be seen in a carrier network for updating at least one updateable electronic device using at least one update package. The carrier network comprises an update store for storing the at least one update package, and at least one update server for selectively retrieving and downloading the at least one update package. The update store and the at least one update server may be located within the same computer. In addition, the at least one updateable electronic device may comprise at least one identifying characteristic and the at least one update package retrieved and downloaded may be the most recent available corresponding to the at least one identifying characteristic. The at least one identifying characteristic may comprise at least one of a manufacturer, a model, a serial number, a software version, and a firmware version.

In an embodiment of the present invention, the carrier network may further comprise at least one provisioning system for providing a list of addresses of each of the at least one updateable electronic device based upon at least one identifying characteristic, where the list of addresses may be used to facilitate the downloading. The at least one identifying characteristic may be at least one of a manufacturer, a model, a serial number, a software version number, a firmware version number, an associated telephone number, and an associated Internet protocol address. The at least one update server may use the list of addresses to send to the corresponding ones of the at least one updateable electronic device notifications of the need to perform an update, and the notifications may be sent according to a predetermined schedule. The downloading, in an embodiment of the present invention, may be performed in push mode, and the push mode may be compliant with a wireless application protocol (WAP) specification. In addition, a user may be prompted to approve the updating of the at least one updateable electronic device, and a user may be prompted to approve the download of the at least one update package. Such an embodiment may further comprise a generator for generating an update package using a first code version and a second code version, and the carrier network may be a wireless network.

Another aspect of the present invention may appear in a generator for generating at least one of an update package and a signature from a first code version and a second code version. The update package is applicable to an updateable electronic device and comprises a set of instructions for describing in a compressed form any differences between the first code version and the second code version. An embodiment of the present invention may further comprise an interface for communicating to a carrier network, at least one of the update package and an identifying characteristic. The signature may be based upon at least one of the update package and a manufacturer identifier.

An additional aspect of the present invention may be observed in a method of operating an update server for updating at least one updateable electronic device from a current code version to a latest updated code version, where the updateable electronic device comprises at least one identifying characteristic. In such an embodiment, the method may comprise receiving an update request from the at least one updateable electronic device, where the request comprises the at least one identifying characteristic, selecting an update package corresponding to the latest updated code version using the at least one identifying characteristic, and dispensing the selected update package to the at least one updateable electronic device. In such an embodiment, the at least one identifying characteristic may be at least one of a manufacturer, a model, a serial number, a software version, and a firmware version.

These and other advantages, aspects, and novel features of the present invention, as well as details of illustrated embodiments, thereof, will be more fully understood from the following description and drawings.

### BRIEF DESCRIPTION OF SEVERAL VIEWS OF THE DRAWINGS

FIG. 1 is block diagram of an exemplary update package generation and distribution network, in accordance with an embodiment of the present invention.

FIG. 2 is block diagram of another exemplary update package generation and distribution network, in accordance with an embodiment of the present invention.

FIG. 3 is a block diagram of yet another exemplary update package generation and distribution network, in accordance with an embodiment the present invention.

FIG. 4 is a block diagram of an exemplary update environment that may correspond to the update environment of FIG. 3, in accordance with an embodiment of the present invention.

FIG. 5 is a block diagram of an exemplary device server that may correspond to the device server of FIG. 4, in accordance with an embodiment of the present invention.

FIG. 6 is a block diagram of an exemplary update store such as the update store of FIG. 4, in accordance with an embodiment of the present invention.

### DETAILED DESCRIPTION OF THE INVENTION

Aspects of the present invention relate generally to the process of generating and distributing update packages for software and/or firmware upgrades, and, more specifically, to the generation of update packages containing firmware/software version changes and the distribution of such update packages to electronic devices connected to a telecommunications network.

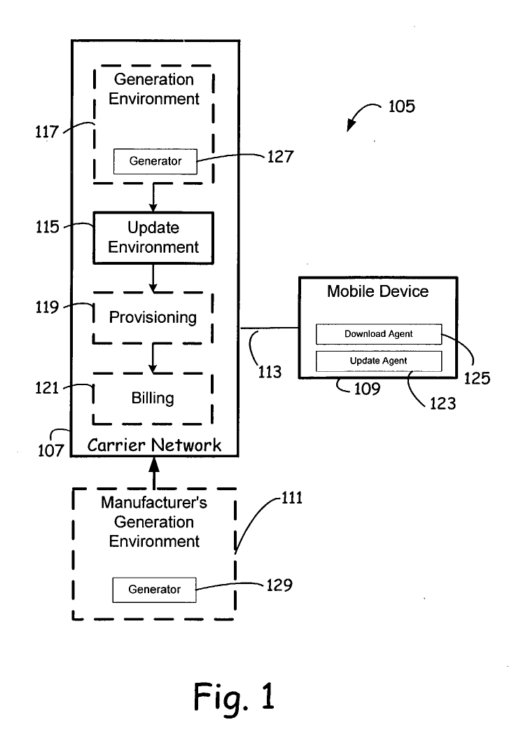

FIG. 1 is block diagram of an exemplary update package generation and distribution network 105, in accordance with an embodiment of the present invention. The update package generation and distribution network 105 comprises a carrier network 107, an optional manufacturer's generation environment 111 communicatively coupled to the carrier network 107, and a mobile device 109 communicatively coupled to the carrier network 107. The carrier network 107 comprises an update environment 115, an optional generation environment 117, an optional provisioning system 119, and an optional billing system 121. Optional generation environment 117 comprises generator 127, and mobile device 109 comprises update agent 123 and download agent 125.

The update package generation and distribution network 105 of FIG. 1 facilitates the generation of update packages, the download of update packages to the mobile device 109 employing pull-mode or push-mode mechanisms over the communication link 113, the transfer of update packages from the manufacturer's generation environment 111, and the creation of billing records. Specifically, the update package generation and distribution network 105 may conduct over-the-air (OTA) updates to firmware and/or software on the mobile device 109 by accessing update packages that are generated by the generation environment 117 or by the manufacturer's generation environment 111 and distributed by the update environment 115. The update packages may comprise, for example, difference information including a set of special instructions for instructing the mobile device 109 how to update a first or current code version or binary image into a second or updated code version or binary image. The difference information may be a compressed description of the operations that must be performed to accomplish the update.

In one embodiment of the present invention, the manufacturer of the mobile device 109 may employ the manufacturer's generation environment 111 to generate update packages for firmware and/or software that can be run on the mobile device 109. The generated update packages may be communicated to the carrier network 107 for testing, storage and eventual distribution to end-users. In a such an embodiment, the generated update packages may be electronically transferred (via ftp, http, or other communication protocols) to the carrier network 107 from the manufacturer's generation environment 111, or they may be communicated to the carrier network 107 using removable media such as, for example, a CDROM, magnetic tape, floppy disk, or removable hard disk drive. In both cases, the generated update packages may be stored by the carrier network 107 in the update environment 115 for eventual distribution to the mobile device 109.

In one embodiment, the mobile device 109 may send a request to determine the availability of update packages. The request may include identifying characteristics such as, for example, a manufacturer identifier, a model identifier, and a version number. Other parameters may also be included in a request, as the present invention is not limited to the above. The update environment 115 may then receive the request, processes the request, determine the availability of appropriate update packages for the mobile device 109, and send a response to mobile device 109 indicating the availability of update packages. When the mobile device 109 receives the availability information, it may proceed to request the initiation of the download of the appropriate update package. In one embodiment, for example, the user may be prompted for approval prior to the request of the update download. The update environment 115 facilitates the retrieval and download of an appropriate update package to the mobile device 109. At the end of the download, the mobile devices verifies that it received an appropriate update package, validates the update package contents employing, for example, CRC checks, an MD5 checksum, etc., and applies the update package to update the existing version of firmware and/or software in mobile device 109.

In another embodiment of the present invention, the latest available update package may be determined to be the appropriate update package for the mobile device when a request or query is received for update package availability. For example, if updates to several different versions of software and/or firmware are available, then the update package that takes the mobile device 109 to the latest software and/or firmware version may be considered as the appropriate update package to be subsequently transferred to the mobile device 109.

In another embodiment of the present invention, the operator of carrier network 107 may be responsible for the generation of update packages. In such an embodiment, the generation environment 117 may be employed to generate the update packages. The generated update packages may then be transferred electronically or via removable media such as, for example, CDROM, magnetic tape, floppy disk, or removable hard disk, to the update environment 115. The update packages may also be tested within the carrier network using a testing environment that is similar to the update environment 115.

An embodiment of the present invention may employ either push or pull mode to deliver an update package to mobile device 109. For example, in one embodiment mobile device 109 may request an update package from the update environment 115 and receive the update package as a download. This is considered a pull-mode operation as the mobile device initiates the download. In another embodiment, the update environment 115 may send a notification to the mobile device 109 to inform it of the availability of update packages. The mobile device 109 may respond to the notification by initiating an update package download from the update environment 115 and subsequently install the downloaded update package.

In yet another embodiment, the update package may be delivered to the mobile device 109 by the update environment 115 in “push-mode”. In such an embodiment, the services of a provisioning system 119 may be employed to determine an address of the mobile device 109 in terms of, for example, its phone number or internet protocol (IP) address. The push mode communication protocol used may comply with, for example, one of the family of Wireless Application Protocol (WAP) specifications. Employing the address of the mobile device 109, the update environment 115 may communicate with the mobile device 109 and determine identifying characteristics such as, for example, the manufacturer, the model number, and firmware and/or software version number(s) appropriate to the mobile device 109. The update environment 115 may then transfer an associated update package to the mobile device 109. In another embodiment, the provisioning system 119 may provide information about the manufacturer, model number and firmware and/or software version number(s) appropriate to the mobile device 109.

If billing-related information is to be collected for update packages transferred to the mobile device 109, the update environment 115 may employ the billing system 121. In addition to such collected billing information, activity logs may be maintained by the update environment 115 to track statistics such as, for example, the number of update packages downloaded and the status of download attempts.

In an embodiment of the present invention, the update package generation process begins at the manufacturer's generation environment 111. Within the manufacturer's generation environment 111 a generator application 129 may be employed to generate update packages based on an analysis of the existing and the new memory binary images. The generator 129 may also produce a signature based upon, for example, the contents of the update package, the manufacturer, the version number, and the date and time. The generated update packages may be published by the manufacturer and communicated to the update environment 115 using, for example, an ftp connection or a CDROM. The update package along with profile data may be stored within the update environment 115 in a component called the update store. Once published, the updates may be made available to data-enabled mobile devices, such as the mobile device 109.

As described above, the update package deployment may be in either “push” or “pull” mode, i.e. update packages can be delivered in a “push” or “pull” fashion through a wireless connection. The mobile device 109 may invoke an update agent 123 as a result of short message service (SMS) messaging or a menu driven item. The update agent 123 may then establish a data connection between the mobile device 109 and the update environment 115. The update agent 123 exchanges profile data with the update environment 115, and more specifically, with a corresponding device server component (described below). The device server then processes this information and returns the appropriate update package specific to the mobile device's 109 current hardware and software profile.

The update package and the existing memory binary image integrity are tested prior to applying the update at the mobile device 109. Following successful verification, the update package may be applied to the existing memory image at the mobile device 109. Fault tolerance and redundancy may be used to permit recovery in the event of power loss or interruption. Once the memory binary image of the mobile device 109 has been fully updated, the update agent 123 in the mobile device 109 may perform a final error check and close the update process.

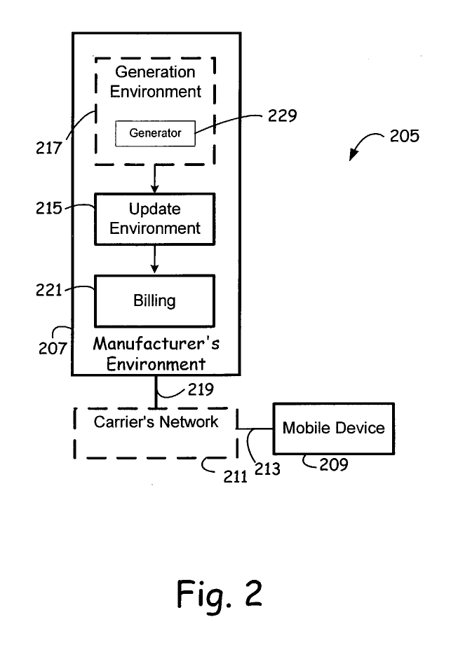

FIG. 2 is block diagram of another exemplary update package generation and distribution network 205, in accordance with an embodiment of the present invention. The update generation and distribution network 205 of FIG. 2 comprises a carrier network 211, a manufacturer's environment 207, and a mobile device 209. The manufacturer's environment 207 comprises an update environment 215, an optional generation environment 217, an optional provisioning system 119, and an optional billing system 221. The optional generation environment 217 comprises generator 229. The manufacturer's environment 207 is communicatively coupled to the mobile device 109 via the carrier network 211 and communication links 213 and 219.

In the illustration of FIG. 2, the update package generation and distribution network 205 is managed by the manufacturer, and the manufacturer's environment 207 not only facilitates the generation and testing of update packages, but also the subsequent download of update packages to the mobile device 109. The mechanism for download may be pull-mode, initiated by the mobile device 209, although push-mode mechanisms may also be employed. Billing activities may be facilitated by the billing system 221.

In one embodiment of the present invention, the manufacturer of the mobile device 209 may employ the manufacturer's generation environment 217 to generate update packages for firmware and/or software on the mobile device 209. The generated update packages may be communicated to the update environment 215 for testing, storage and eventual distribution to end-users.

In another embodiment, the update environment 215 in the manufacturer's environment 207 may be accessible from the mobile device 209 over one or more carrier networks 211. The mobile device 209 may be capable of accessing the manufacturer's environment 207 regardless of the carrier network 211 it is employing. The manufacturer's environment 207 may employ security mechanisms to not only authenticate the mobile device 209, but also to restrict the access to a specific group of end-users.

In yet another embodiment of the present invention, the manufacturer's environment 207 may be capable of scheduling downloads of update packages according to specific subsets of mobile device end users, and to notify the end-users about the availability of update packages accordingly. For example, all mobile devices 209 belonging to a certain set of manufacturing serial numbers may be considered as targets for a software and/or firmware update and the mobile devices 209 may be sent notifications regarding the update. The notifications may be sent per a schedule of updates that is managed by the manufacturer's environment 207. The update environment 215 may maintain the schedules and may monitor the downloads of update packages by the mobile device 209.

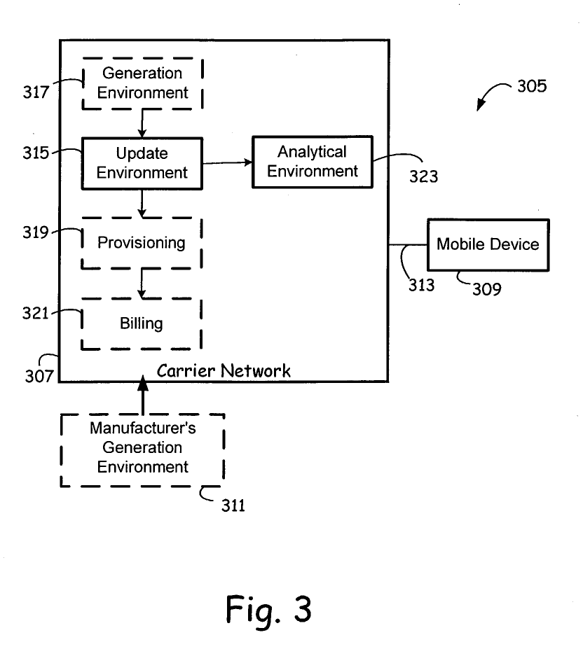

FIG. 3 is a block diagram of yet another exemplary update package generation and distribution network 305, in accordance with an embodiment of the present invention. In the illustration of FIG. 3, the update environment 315 is communicatively coupled to an analytical environment 323, and a communication mechanism is provided to feed data from the update environment 315 to the analytical environment 323. The addition of the analytical environment 323 makes it possible to offload most data analysis activities from the update environment 315 to the analytical environment 323, thus making the delivery of update packages efficient while providing for the analysis of upload package download statistics and reporting of various types. In this embodiment, the update environment 315 may support the download of update packages by a large number of mobile users, and may track the status of downloads by the mobile devices 309. The analysis of download information, however, may be offloaded to the analytical environment 323. Some of the primary analytical tasks are, for example, the generation of various types of reports, interaction with the carrier network's customer care interfaces, and analysis of various types of operations-related data based on, for example, the manufacturer, the model, and the software and/or firmware versions of mobile device 309. The update environment 315 may provide update package download services and may communicate customer and status information to the analytical environment 323 for subsequent manipulation, aggregation and reporting.

The carrier network 307 decouples the issues of content management and content publishing that are handled by the generation environment, from the end-user access supported by the update environment 315, and the analysis of operational data facilitated by the analytical environment 323. In addition, the update environment 315 may also comprise a propagation layer (not shown) that is responsible for propagating update packages and other content among the various subsystems and/or components of the update environment 315. For example, the propagation layer may be used for propagating content (update packages) to various servers and caches for eventual end-user access.

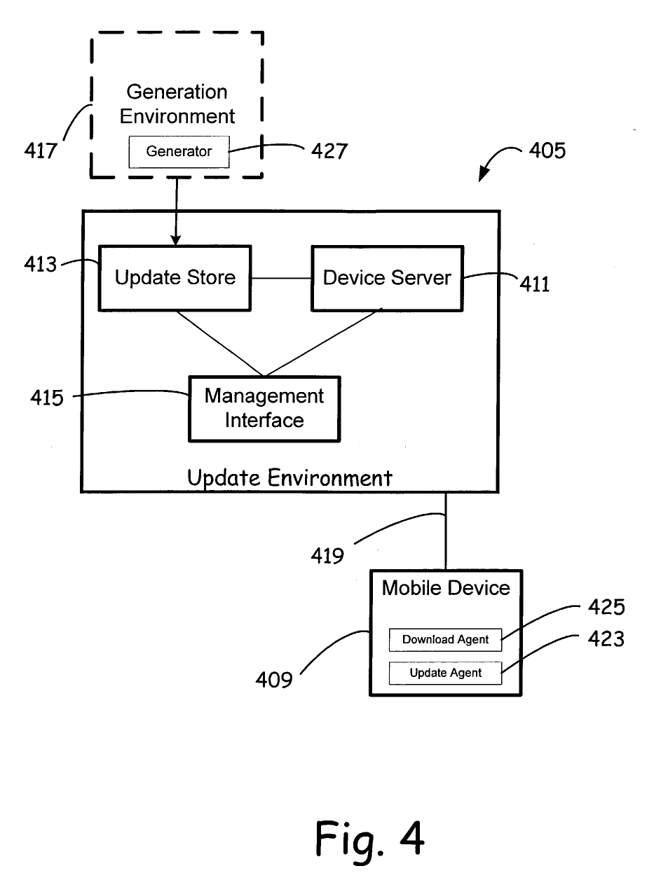

FIG. 4 is a block diagram of an exemplary update environment 405 that may correspond to the update environment 315 of FIG. 3, in accordance with an embodiment of the present invention. The update environment 405 provides access to update packages to a mobile device 409. A generation environment 417 communicatively coupled to the update environment 405 generates the update packages. The update environment 405 comprises an update store 413 that may be used to store and retrieve update packages, and a device server 411 that receives requests from the mobile device 409 and facilitates communication of update packages to the mobile device 409, employing the appropriate protocol translations. The generation environment 417 comprises a user-friendly generator application 427 that creates update packages from an existing and a new version of software and/or firmware for the mobile device 409.

In the illustration of FIG. 4, the update environment 405 represents the aggregate functionality of the system to store, manage, and distribute individual update packages to constrained devices such as the mobile device 409. The device server 411 of the update environment 405 controls the deployment and management of update packages. The device server 411 provides the update application communication to the update agent 423 embedded within the mobile device 409. Other functions of the device server 411 include, for example, determining the correct update package for the device, providing communications interfaces to the mobile device 409 (e.g., mobile wireless network, fixed wireless network, wireless LANs or physical cables), providing support for a variety of wireless network communications protocols (e.g., GSM, CDMA, iDEN, PDC, CDPD, GPRS, EDGE, etc.), and providing support of operations, administration, maintenance and provisioning (OAM&P) functions.

The update store 413 of FIG. 4 is the repository for the update packages to be distributed to mobile device 409. The update packages may be generated by the generator 427 within the generator environment 417 and transferred to the update store 413 via the management interface 415. Functions of the update store 413 include, for example, database management of the update packages, providing an interface to the device server 411, providing interfaces to the management interface 415, and maintaining device update scheduling.

The management interface 415 is the user interface to the update environment 405. Through the management interface 415, an operator may, for example, provide update packages from the generation environment to the update store 413 and configure and control the update store 413 and the device server 411. OAM&P operations may also be performed from this interface.

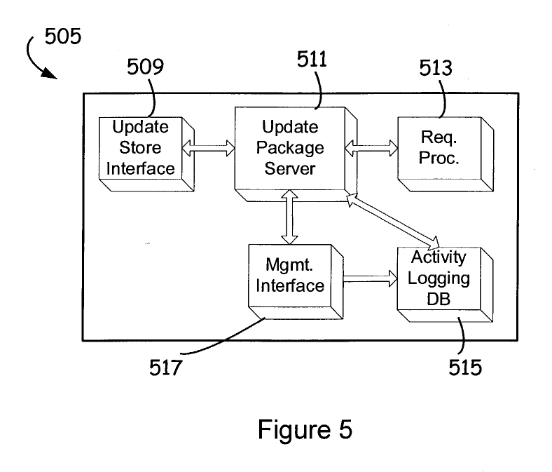

FIG. 5 is a block diagram of an exemplary device server that may correspond to the device server 411 of FIG. 4, in accordance with an embodiment of the present invention. As shown in FIG. 4, the device server 411 comprises an update store interface 509, an update package server 511, a request processing system 513, a management interface 517, and an activity-logging database 515. The update store interface 509 provides a mechanism to interact with an update store, such as update store 413 of FIG. 4, in order to retrieve update packages and related data. The update package server 511 may provide the ability to handle multiple simultaneous connections with a plurality of mobile devices such as mobile device 409 of FIG. 4, thus providing for simultaneous interactions with a plurality of mobile devices 409 in an “over-the-air” mode. The update package server 511 may forward to the request processing system 513 incoming requests for update packages or other forms of inquiry that may be received from the mobile devices 409. The request processing system 513 may determine the availability of update packages based on identifying characteristics or parameters provided by the mobile device 409 in its inquiry/request. Examples of identifying characteristics include items such as the manufacturer, the model, and the software and/or firmware version number(s).

Activities and events of interest may be logged in an activity-logging database 515 which may be an external database, or a part of the update store 413. The management interface 517 may make it possible to manage the device server 505 and configure its functionality.

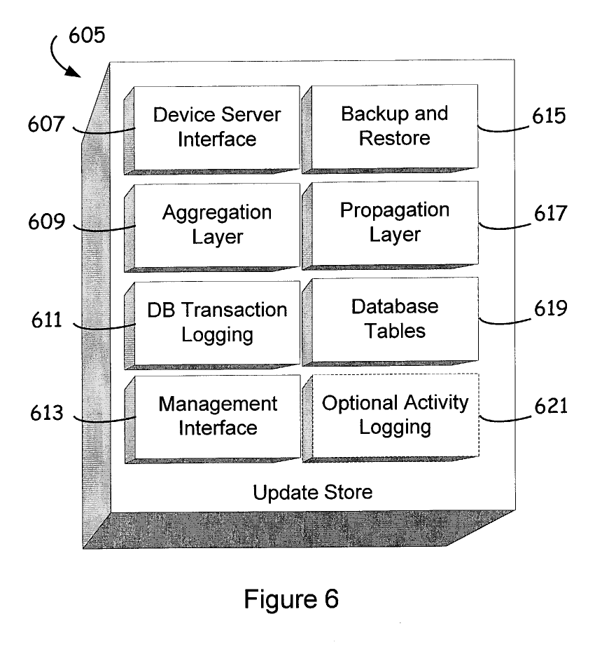

FIG. 6 is a block diagram of an exemplary update store 605 such as the update store 413 of FIG. 4, in accordance with an embodiment of the present invention. In the illustration of FIG. 6, the update store 605 comprises a device server interface 607, an optional aggregation layer 609, a database transaction logging system (e.g., a commercial database) 611, a management interface 613, a backup and restore system 615, a propagation layer 617, database tables 619, and an optional activity-logging database 621. The optional aggregation layer 609 facilitates aggregation of operational data collected from one or more device servers such as device server 505 of FIG. 5, for analysis and other purposes. The propagation layer 617 provides support for propagating update packages when there is a hierarchy of update stores to be maintained. In such an embodiment, each update store may correspond to an update store such as update store 413 of FIG. 4 and may be responsible for propagating update packages to other update stores 413 lower in the hierarchy. The database tables 619 may provide support for storage and retrieval of update packages and associated information. In one embodiment, the optional activity-logging database 621 may be integrated with the database tables 619.

In an embodiment of the present invention, the hardware for the update store 605 may comprise, for example, two Sun StorEdge A1000 RAID storage arrays. These storage arrays may be managed by two Sun Netra servers utilizing third-party carrier-grade database software. Additional storage arrays and management servers may be added to increase capacity and provide scalability.

The update package generation and distribution network 105 of FIG. 1 employs a scalable architecture. A plurality of device servers 505 of FIG. 5 may be employed in the update environment, all sharing a single update store 605. A plurality of update stores 605 may also be employed, if necessary, to scale the solution to support a large number of mobile devices 409.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

Notwithstanding, the invention and its inventive arrangements disclosed herein may be embodied in other forms without departing from the spirit or essential attributes thereof Accordingly, reference should be made to the following claims, rather than to the foregoing specification, as indicating the scope of the invention. In this regard, the description above is intended by way of example only and is not intended to limit the present invention in any way, except as set forth in the following claims.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. An updateable electronic device communicatively coupled to a carrier network, the device comprising:
at least one of a firmware and a software; and
at least one identifying characteristic, wherein the updateable electronic device communicates the at least one identifying characteristic to the carrier network and receives an indication sent by the carrier network of the need to update at least one of the firmware and the software.

2. The updateable electronic device of claim 1 further comprising a download agent for downloading an update package sent from the carrier network and for verifying that the downloaded update package is appropriate for the updateable electronic device.

3. The updateable electronic device of claim 2 further comprising an update agent for updating at least one of the firmware and the software using the update package sent by the carrier network.

4. A method of operating a carrier network, the carrier network communicatively coupled to at least one updateable electronic device comprising a code and at least one identifying characteristic, the method comprising:
receiving from the at least one updateable electronic device the at least one identifying characteristic; and
sending to the at least one updateable electronic device a signal indicating a need to perform an update of the code based upon the at least one identifying characteristic.

5. The method of claim 4 wherein the code is at least one of firmware and software.

6. The method of claim 4 wherein the carrier network is a wireless network.

7. The method of claim 4 wherein the at least one updateable electronic device comprises an update agent, and the receiving comprises:
under the control of the update agent,
accepting an update package from the carrier network; and
updating the code in the updateable electronic device using the update package.

8. The method of claim 7 wherein the at least one updateable electronic device comprises a download agent, and wherein the accepting comprises:
under the control of the download agent,
downloading the update package from the carrier network; and
verifying that the update package is appropriate for the at least one updateable electronic device.

9. An update network comprising at least one updateable electronic device communicatively coupled to a server, the server having stored thereon at least one update package, the updateable electronic device comprising an update agent for retrieving the at least one update package and a download agent for verifying that the at least one update package is appropriate for the at least one updateable electronic device.

10. The update network of claim 9 wherein the at least one update package comprises at least one of software and firmware.

11. The update network of claim 9 wherein the verifying comprises checking that the update package originated from the manufacturer of the updateable electronic device.

12. A method of operating an update network, the update network comprising at least one updateable electronic device communicatively coupled to a server, the updateable electronic device comprising at least one of a software and a firmware and being characterized by its manufacturer, the server for storing at least one update package, the method comprising:
under control of the server,
receiving the at least one update package;
storing the at least one update package on the server if the at least one update package was generated by the manufacturer of the at least one updateable electronic device;
determining that the at least one updateable electronic device needs to be updated; and
notifying the at least one updateable electronic device that an update is needed;
under control of the at least one updateable electronic device,
receiving a notification the update is needed;
requesting from the server the at least one update package;
accepting the at least one update package;
verifying the at least one update package; and
updating at least one of the software and the firmware of the updateable electronic device using the at least one update package.

13. An update network comprising at least one updateable electronic device communicatively coupled to a plurality of servers, each of the plurality of servers comprising a propagation layer for propagating a plurality of update packages from at least one of the plurality of servers to the others of the plurality of servers, the update network managing the propagation of the plurality of update packages.

14. The update network of claim 13 wherein each of the plurality of servers comprises an aggregation layer for aggregating information related to the operation of the plurality of servers, and wherein the update network manages the aggregation.

15. A carrier network for updating a plurality of updateable electronic devices from a first operating code to a second operating code in an over-the-air mode, each of the plurality of updateable electronic devices comprising a memory containing a copy of the first operating code and at least one identifying characteristic, wherein the updating to the same second operating code of those of the plurality of updateable electronic devices having the same at least one identifying characteristic results in identical memory contents.

16. A carrier network for updating at least one updateable electronic device using at least one update package, the carrier network comprising:
an update store for storing the at least one update package; and
at least one update server for selectively retrieving and downloading the at least one update package.

17. The carrier network of claim 16 wherein the update store and the at least one update server are located within the same computer.

18. The carrier network of claim 16 wherein the at least one updateable electronic device comprises at least one identifying characteristic and the at least one update package retrieved and downloaded is the most recent available corresponding to the at least one identifying characteristic.

19. The carrier network of claim 18 wherein the at least one identifying characteristic comprises at least one of a manufacturer, a model, a serial number, a software version, and a firmware version.

20. The carrier network of claim 16 further comprising at least one provisioning system for providing a list of addresses of each of the at least one updateable electronic device based upon at least one identifying characteristic, wherein the list of addresses is used to facilitate the downloading.

21. The carrier network of claim 20 wherein the at least one identifying characteristic is at least one of a manufacturer, a model, a serial number, a software version number, a firmware version number, an associated telephone number, and an associated Internet protocol address.

22. The carrier network of claim 20 wherein the at least one update server uses the list of addresses to send to the corresponding ones of the at least one updateable electronic device notifications of the need to perform an update.

23. The carrier network of claim 22 wherein the notifications are sent according to a predetermined schedule.

24. The carrier network of claim 16 wherein the downloading is performed in push mode.

25. The carrier network of claim 24 wherein the push mode is compliant with a wireless application protocol (WAP) specification.

26. The carrier network of claim 16 wherein a user is prompted to approve the updating of the at least one updateable electronic device.

27. The carrier network of claim 16 wherein a user is prompted to approve the download of the at least one update package.

28. The carrier network of claim 16 further comprising a generator for generating an update package using a first code version and a second code version.

29. The carrier network of claim 16 wherein the carrier network is a wireless network.

30. A generator for generating at least one of an update package and a signature from a first code version and a second code version, the update package being applicable to an updateable electronic device and comprising a set of instructions for describing in a compressed form any differences between the first code version and the second code version.

31. The generator of claim 30 further comprising an interface for communicating to a carrier network at least one of the update package and an identifying characteristic.

32. The generator of claim 30 wherein the signature is based upon at least one of the update package and a manufacturer identifier.

33. A method of operating an update server for updating at least one updateable electronic device from a current code version to a latest updated code version, the updateable electronic device comprising at least one identifying characteristic, the method comprising:
receiving an update request from the at least one updateable electronic device, the request comprising the at least one identifying characteristic;
selecting an update package corresponding to the latest updated code version using the at least one identifying characteristic; and
dispensing the selected update package to the at least one updateable electronic device.

34. The method of claim 33 wherein the at least one identifying characteristic is at least one of a manufacturer, a model, a serial number, a software version, and a firmware version.
